(19) United States
(12) Patent Application Publication
(10) Pub. No.: US 2023/0139182 A1
(43) Pub. Date: May 4, 2023

(54) COMPOSITE OPTICAL FILM AND THE METHOD TO MAKE THE SAME

(71) Applicant: UBRIGHT OPTRONICS CORPORATION, Taoyuan City (TW)

(72) Inventors: Chia-Yeh Miu, Taoyuan City (TW); Lung-Pin Hsin, Taoyuan City (TW); Hui-Yong Chen, Taoyuan City (TW); Chia-Jung Chiang, Taoyuan City (TW); Ge-Wei Lin, Taoyuan City (TW); Ying-Yi Lu, Taoyuan City (TW); Chien-Chih Lai, Taoyuan City (TW); CHING-AN YANG, Taoyuan City (TW); Yu-Mei Juan, Taoyuan City (TW)

(21) Appl. No.: 17/975,635

(22) Filed: Oct. 28, 2022

Related U.S. Application Data
(60) Provisional application No. 63/273,154, filed on Oct. 29, 2021.
(60) Provisional application No. 63/279,187, filed on Nov. 15, 2021.

(51) Int. Cl. F21V 9/32; F21V 5/02

(52) U.S. Cl. CPC F21V 9/32; F21V 5/02

(57) ABSTRACT

A composite optical film, comprising: a quantum-dot film and a first optical film disposed over the quantum-dot film, wherein a first plurality of multi-faceted recesses are formed on a first surface of the first optical film, wherein each multi-faceted recess comprises a shape of a reversed cone.

### CROSS-REFERENCE TO RELATED APPLICATION

This application claims the benefit of U.S. provisional patent application No. 63/273,154, filed on Oct. 29, 2021 and U.S. provisional patent application No. 63/279,187, filed on Nov. 15, 2021, each of the above applications is hereby incorporated herein by reference.

### BACKGROUND OF THE INVENTION

### 1. Field of the Invention

The present invention relates to a quantμm-dot film, and more particularly to a composite optical film.

### 2. Description of Related Art

High brightness, higher light-splitting effect, high resolution, and “thin and light” are the directions of displays. However, to achieve the above-mentioned goals, the overall thickness of the backlight module will be too high by using conventional methods.

Furthermore, the conventional methods cannot achieve the true Roll-to-Roll manufacturing process for mass production.

Accordingly, the present invention proposes a new solution to overcome the above-mentioned disadvantages.

### SUMMARY OF THE INVENTION

One objective of the present invention is to form a multi-faceted recess structure on an optical film by a roller having a polyhedron structure protruded thereon, such that the multi-faceted recess structure on the optical film is continuous with no joints structure for roll-to-roll mass production.

In one embodiment, a composite optical film is disclosed, wherein the composite optical film comprises: a quantμm-dot film, comprising a quantμm-dot layer and a first plurality of prisms disposed over the quantμm-dot layer; a first optical film, disposed over the quantμm-dot film, wherein a first plurality of multi-faceted recesses are formed on a first surface of the first optical film, wherein each multi-faceted recess of the first plurality of multi-faceted recesses comprises a shape of a reversed cone.

In one embodiment, each multi-faceted recess of the first plurality of multi-faceted recesses comprises a shape of a reversed pyramid.

In one embodiment, a second optical film is disposed over the first optical film, wherein a second plurality of multi-faceted recesses are formed on a first surface of the first optical film, wherein each multi-faceted recess of the second plurality of multi-faceted recesses comprises a shape of a reversed pyramid.

In one embodiment, a blue light transmissive film is disposed under the quantμm-dot film, wherein the blue light transmissive film is capable of enhancing the transmittance of blue light and increasing the reflectivity of red and green light.

In one embodiment, the blue light transmissive film is attached to a bottom surface of the quantμm-dot film by a third adhesive layer disposed between the bottom surface of the quantμm-dot film and a top surface of the blue light transmissive film.

In one embodiment, a first brightness enhancement film is disposed over the second optical film.

In one embodiment, a second brightness enhancement film is disposed over the first brightness enhancement film.

In one embodiment, a method to form a composite optical film is disclosed, wherein the method comprises: forming a quantμm-dot film, comprising a quantμm-dot layer and a first plurality of prisms disposed over the quantμm-dot layer; and forming a first optical film, disposed over the quantμm-dot film, wherein a first plurality of multi-faceted recesses are formed on a first surface of the first optical film, wherein each multi-faceted recess of the first plurality of multi-faceted recesses comprises a shape of a reversed cone.

In one embodiment, the method further comprises: forming a second optical film, disposed over the first optical film, wherein a second plurality of multi-faceted recesses are formed on a first surface of the first optical film, wherein each multi-faceted recess of the second plurality of multi-faceted recesses comprises a shape of a reversed cone.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1A illustrates a schematic top view of an optical film according to one embodiment of the present invention;

FIG. 1B illustrates a schematic top view of an optical film according to one embodiment of the present invention;

FIG. 2A illustrates a schematic top view of attaching two optical films according to one embodiment of the present invention;

FIG. 2B illustrates a schematic top view of attaching two optical films according to one embodiment of the present invention;

FIG. 2C illustrates a method to form a structure on a mold.

FIG. 2D illustrates a local surface area of the mold.

FIG. 2E illustrates a view of forming multiple multi-faceted recesses on a substrate by using the mold.

FIG. 2F illustrates a tip head shape of a blade to cut the mold.

FIG. 2G illustrates a round head shape of a blade to cut the mold.

FIG. 2H illustrates a polygon head shape of a blade to cut the mold.

FIG. 2I illustrates a reversed round head shape of a blade to cut the mold.

FIG. 2J illustrates a conical structure formed on the substrate in FIG. 1A and FIG. 1B.

FIG. 2K illustrates another conical structure formed on the substrate in FIG. 1A and FIG. 1B.

FIG. 2L illustrates another conical structure formed on the substrate in FIG. 1A and FIG. 1B.

FIG. 2M illustrates a cross-sectional view, wherein the top surface of the substrate has a first plurality of multi-faceted recesses and the bottom surface of the substrate has a second plurality of multi-faceted recesses.

FIG. 2N illustrates a photo that shows a conical recess structure on a top surface of the substrate.

FIG. 2O illustrates a photo that shows the light-splitting effect of the conical recess structure in FIG. 2M.

FIG. 2P illustrates a photo that shows the light-splitting effect of the conical recess structures when each of the top surface and the bottom surfaces has the structure in FIG. 2M.

FIG. 2Q illustrates a method for forming an optical film.

FIG. 3A illustrates a schematic top view of a composite optical film according to one embodiment of the present invention;

FIG. 3B illustrates a schematic top view of a composite optical film according to one embodiment of the present invention;

FIG. 3C illustrates a schematic top view of a composite optical film according to one embodiment of the present invention;

FIG. 4A illustrates a schematic top view of a backlight module according to one embodiment of the present invention;

FIG. 4B illustrates a schematic top view of a backlight module according to one embodiment of the present invention;

FIG. 4C illustrates a schematic top view of a backlight module according to one embodiment of the present invention;

FIG. 5 illustrates a method to form an optical film according to one embodiment of the present invention; and

FIG. 6 illustrates a method to form an optical film according to one embodiment of the present invention.

### DESCRIPTIONS OF THE ILLUSTRATED EMBODIMENTS

The detailed explanation of the present invention is described as follows. The described preferred embodiments are presented for purposes of illustrations and description and they are not intended to limit the scope of the present invention.

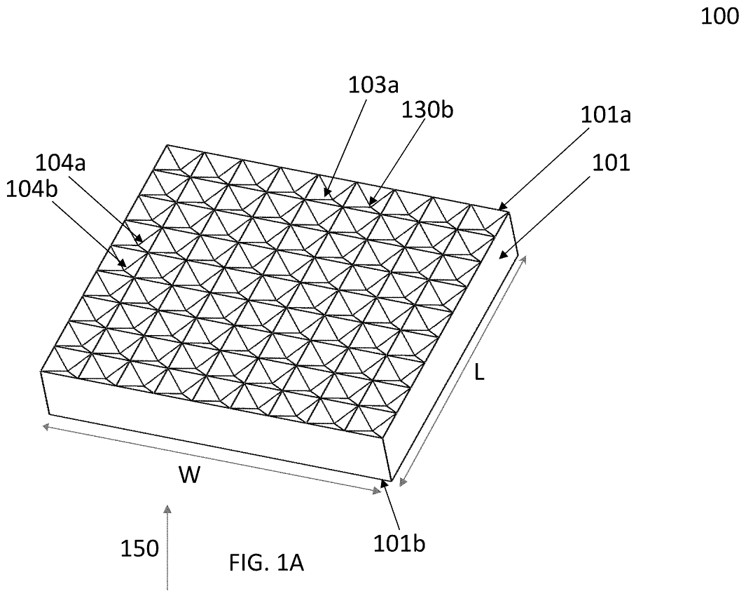

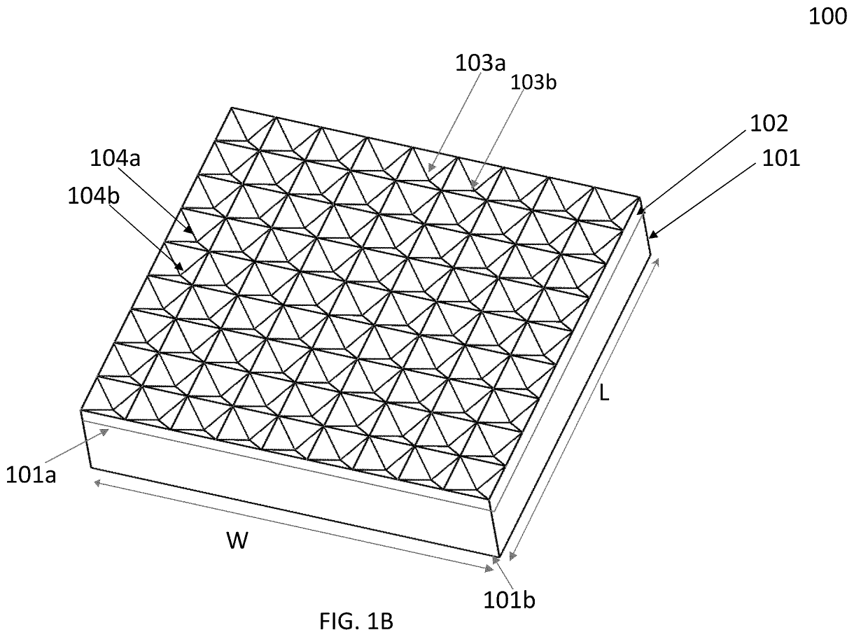

FIG. 1A illustrates a schematic top view of an optical film 100 according to one embodiment of the present invention, wherein the optical film 100 comprises a substrate 101, wherein a plurality of multi-faceted recesses 103a, 103b, 104a, 104b are formed on a first surface 101a of the substrate 101, wherein the plurality of multi-faceted recesses 103a, 103b, 104a, 104b are capable of scattering lights 150 that enter into a second surface 101b of the substrate 101, wherein the first surface 101a and the second surface 101b are two opposite surfaces of the substrate 101.

In one embodiment, the multi-faceted recess comprises at least three side surfaces.

In one embodiment, multiple multi-faceted recesses 104a, 104b of the plurality of multi-faceted recesses are distributed along the length L of the substrate.

In one embodiment, multiple multi-faceted recesses 103a, 103b of the plurality of multi-faceted recesses are distributed along the width W of the substrate 101.

In one embodiment, multiple multi-faceted recesses of the plurality of multi-faceted recesses 104a, 104b are distributed side by side along the length L of the substrate. That is, there is no gap between two adjacent multi-faceted recesses 104a, 104b.

In one embodiment, multiple multi-faceted recesses 103a, 103b of the plurality of multi-faceted recesses are distributed side by side along the width W of the substrate. That is, there is no gap between two adjacent multi-faceted recesses 103a, 103b.

In one embodiment, multiple multi-faceted recesses of the plurality of multi-faceted recesses 104a, 104b are distributed side by side along the length L of the substrate, and multiple multi-faceted recesses 103a, 103b of the plurality of multi-faceted recesses are distributed side by side along the width W of the substrate. That is, there is no gap between two adjacent multi-faceted recesses 104a, 104b, and there is no gap between two adjacent multi-faceted recesses 103a, 103b.

FIG. 1B illustrates a schematic top view of an optical film 100 according to one embodiment of the present invention, wherein the optical film 100 comprises a substrate 101, wherein a first surface 101a of the substrate 101 is coated with a material 102 comprising resin, wherein a plurality of multi-faceted recesses 103a, 103b, 104a, 104b are formed in the photocurable resin 102, wherein the plurality of multi-faceted recesses 103a, 103b, 104a, 104b are capable of scattering lights 150 that enter into a second surface 101b of the substrate 101, wherein the first surface 101a and the second surface 101b are two opposite surfaces of the substrate 101.

In one embodiment, material 102 comprises PMMA (polymethyl methacrylate). In one embodiment, material 102 comprises photocurable resin, such as Epoxy, Acrylate, Polyamide, Polyimide, and Polyisoprene.

In one embodiment, in FIG. 1A and FIG. 1B, the multi-faceted recess comprises a shape of reversed cone.

In one embodiment, in FIG. 1A and FIG. 1B, the multi-faceted recess comprises a shape of reversed cone with at least three side surfaces.

In one embodiment, in FIG. 1A and FIG. 1B, multiple multi-faceted recesses 104a, 104b of the plurality of multi-faceted recesses are distributed along the length L of the substrate.

In one embodiment, in FIG. 1A and FIG. 1B, multiple multi-faceted recesses 103a, 103b of the plurality of multi-faceted recesses are distributed along the width W of the substrate 101.

In one embodiment, in FIG. 1A and FIG. 1B, multiple multi-faceted recesses of the plurality of multi-faceted recesses 104a, 104b are distributed side by side along the length L of the substrate. That is, there is no gap between two adjacent multi-faceted recesses 104a, 104b.

In one embodiment, in FIG. 1A and FIG. 1B, multiple multi-faceted recesses 103a, 103b of the plurality of multi-faceted recesses are distributed side by side along the width W of the substrate. That is, there is no gap between two adjacent multi-faceted recesses 103a, 103b.

In one embodiment, in FIG. 1A and FIG. 1B, multiple multi-faceted recesses of the plurality of multi-faceted recesses 104a, 104b are distributed side by side along the length L of the substrate, and multiple multi-faceted recesses 103a, 103b of the plurality of multi-faceted recesses are distributed side by side along the width W of the substrate. That is, there is no gap between two adjacent multi-faceted recesses 104a, 104b, and there is no gap between two adjacent multi-faceted recesses 103a, 103b.

In one embodiment, in FIG. 1A and FIG. 1B, each of the plurality of multi-faceted recesses 103a, 103b, 104a, 104b is a conical recess.

In one embodiment, in FIG. 1A and FIG. 1B, each of the plurality of multi-faceted recesses 103a, 103b, 104a, 104b is a reversed-pyramid recess.

In one embodiment, in FIG. 1A and FIG. 1B, each of the plurality of multi-faceted recesses comprises four slopped side surfaces, wherein each sloped side surface leans inward.

In one embodiment, in FIG. 1A and FIG. 1B, each of the plurality of multi-faceted recesses comprises at least three slopped side surfaces and a bottom surface, wherein each sloped side surface leans inward to the bottom surface.

In one embodiment, in FIG. 1A and FIG. 1B, each of the plurality of multi-faceted recesses comprises four slopped side surfaces and a bottom surface, wherein each sloped side surface leans inward to the bottom surface.

In one embodiment, in FIG. 1A and FIG. 1B, the second surface of the substrate comprises a microstructure having an uneven appearance to enhance the optical haze.

In one embodiment, in FIG. 1A and FIG. 1B, the microstructure is formed by coating an organic polymer with a plurality of particles embedded therein.

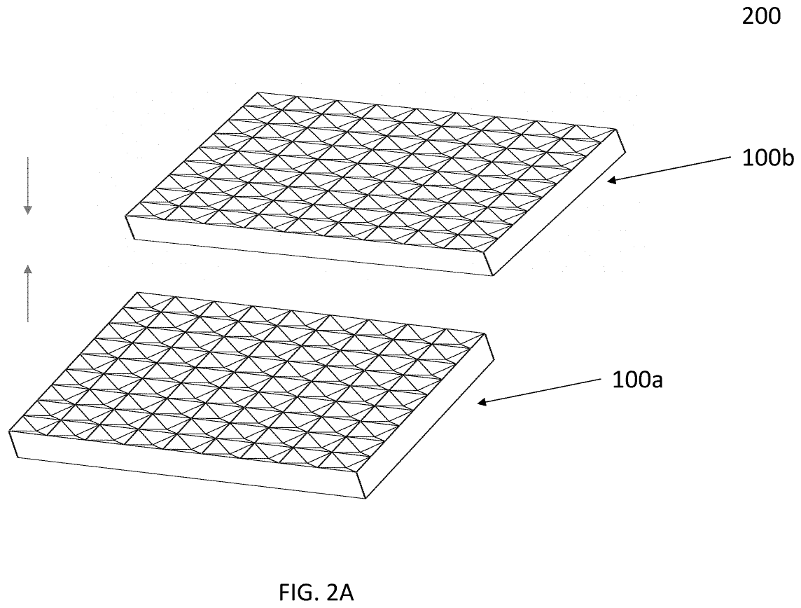

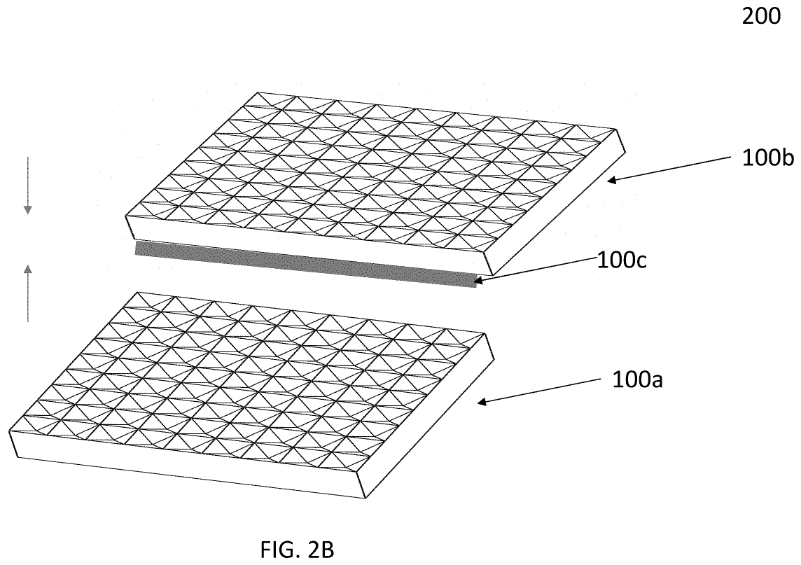

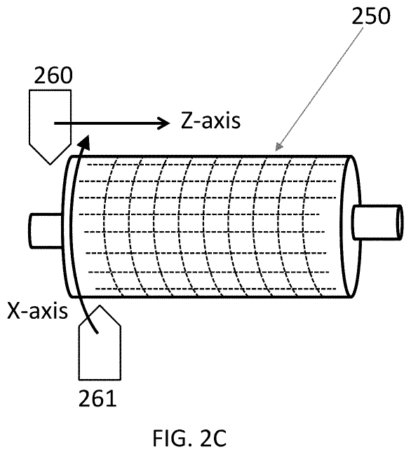

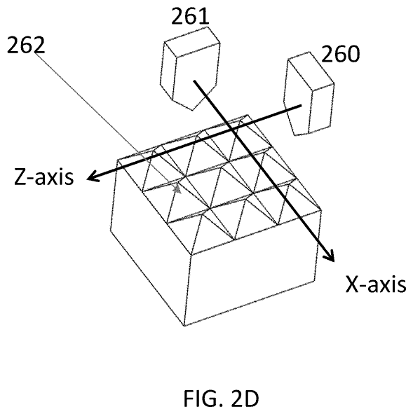

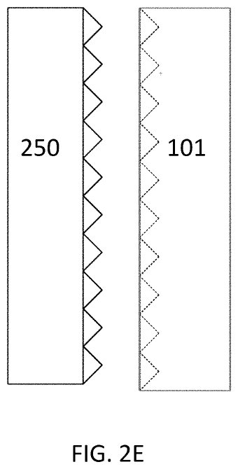

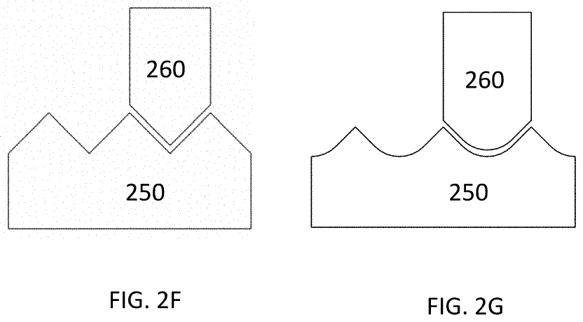

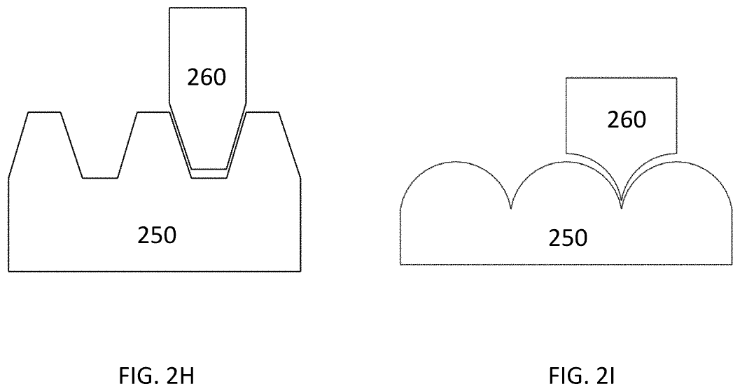

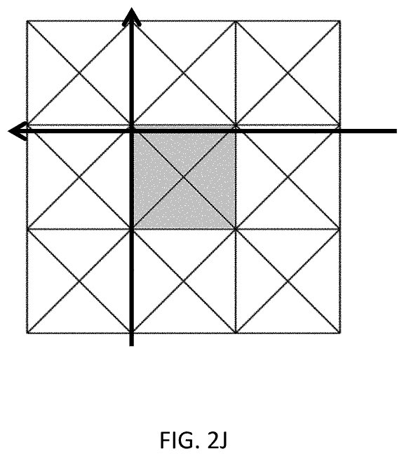

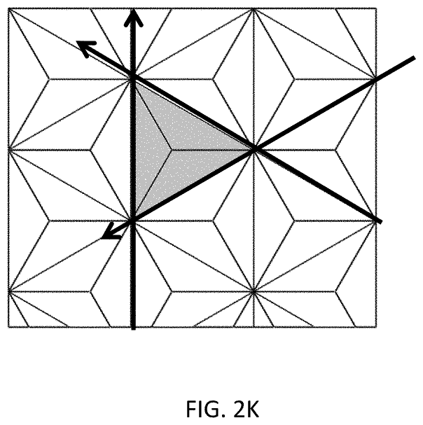

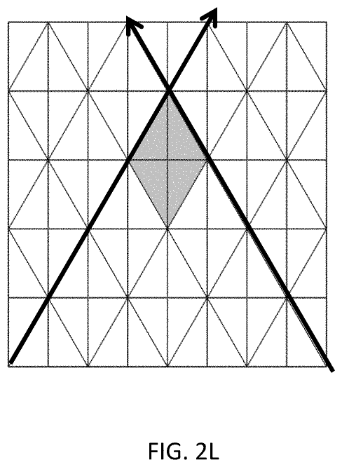

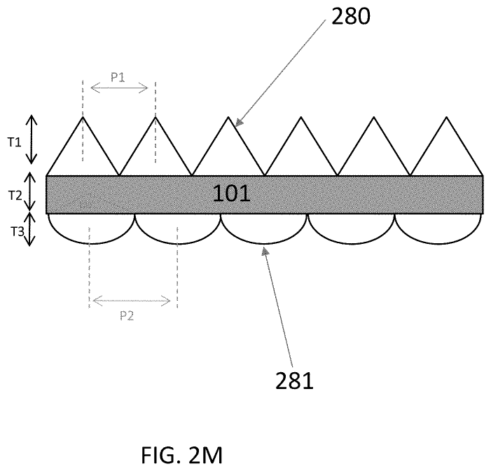

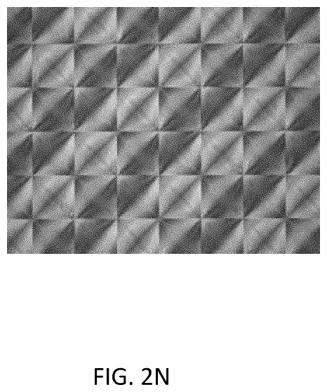

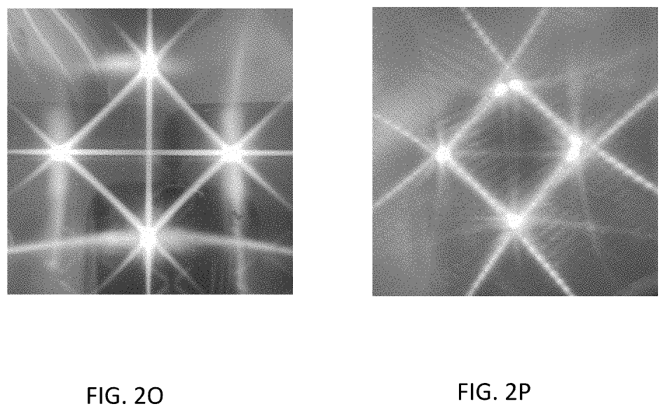

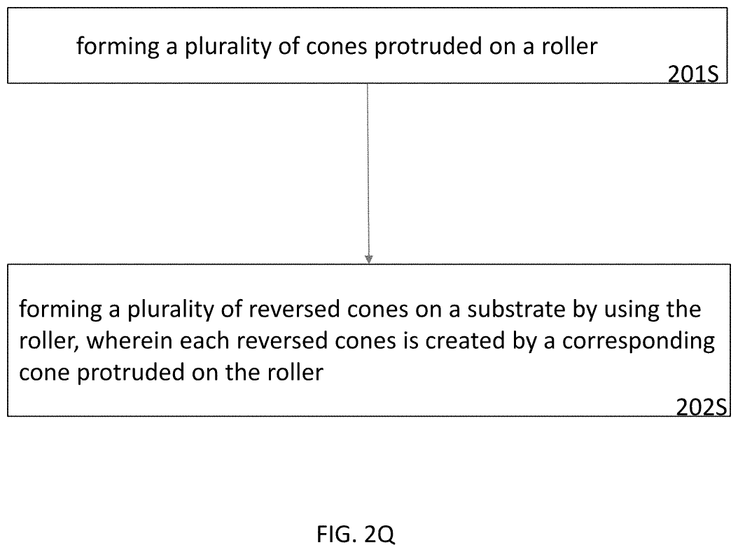

FIG. 2A illustrates a schematic top view of attaching two optical films 100a, 100b according to one embodiment of the present invention, each of the optical films 100a, 100b is as shown in FIG. 1A or FIG. 1B, together to form a double-sheet optical film 200 according to one embodiment of the present invention.

In one embodiment, as shown in FIG. 2B, two optical films 100a, 100b are attached by an adhesive layer 100c.

FIG. 2C illustrates a method to form a structure on a mod 250 for forming multiple multi-faceted recesses of an optical film 100 according to one embodiment of the present invention, each of the optical films 100 is as shown in FIG. 1A or FIG. 1B, wherein the mold 250 is engraved by different tools such as blades 260, 261 in different directions, wherein one blade 260 is cutting in X-axis direction and another blade 261 is cutting in the Z-axis direction to form a conical, such as a pyramid, structure protruded on the mod 250, such as a roller.

In one embodiment, the multi-faceted recess comprises at least three side surfaces.

FIG. 2D illustrates a local surface area of mod 250, wherein one blade 260 is cutting in the X-axis direction and another blade 261 is cutting in the Z-axis direction to form a conical, such as a pyramid, structure 262 on the mod 250, such as a roller.

FIG. 2E illustrates a view of forming multiple multi-faceted recesses on the substrate 101 by using the mod 250 for forming an optical film 100.

FIG. 2F illustrates a tip shape of the blades 260 with a tip angle range between 60 degrees and 120 degrees to cut the 250 in the X-axis direction. The same can be shown for the Z-axis direction by using blade 261 to cut the mod 250.

FIG. 2G illustrates a round head shape of the blade 260 with a radius of the round head shape between 2 μm˜250μm in the X-axis direction. The same can be shown for the Z-axis direction by using blade 261 to cut the mod 250.

FIG. 2H illustrates a polygon shape of the blade 260 with the width of the of the polygon between 2 μm˜60 μm in the X-axis direction. The same can be shown for the Z-axis direction by using blade 261 to cut the mod 250.

FIG. 2I illustrates a reversed round head shape of the blade 260 with a radius of the reversed round head shape between 2 μm˜250 μm in the X-axis direction. The same can be shown for the Z-axis direction by using blade 261 to cut the mod 250.

FIG. 2J illustrates a square cone formed on the substrate 101 in FIG. 1A and FIG. 1B by the corresponding structure protruding on the mod 250.

FIG. 2K illustrates a tri-angle cone formed on the substrate 101 in FIG. 1A and FIG. 1B by the corresponding structure protruding on the mod 250.

FIG. 2L illustrates a pyramid formed on the substrate 101 in FIG. 1A and FIG. 1B by the corresponding structure protruding on the mod 250.

Please note that each of the top surface and the bottom surfaces of the substrate 101 can have a structure formed by a mod that has a corresponding structure formed by any one of the cutting tools shown in FIG. 2F, FIG. 2G, FIG. 2H and FIG. 2I.

FIG. 2M illustrates a cross-sectional view of an optical film, wherein the top surface of a substrate 101 comprises a first structure that comprises a first plurality of multi-faceted recesses 280 formed by a mod having a corresponding structure formed by the cutting tool shown in FIG. 2F. The bottom surface of the substrate 101 comprises a second structure that comprises a second plurality of multi-faceted recesses 281 formed by a mod having a corresponding structure formed by the cutting tool shown in FIG. 2I. In one embodiment, the pitch P1 of between each two adjacent multi-faceted recesses of the first plurality of multi-faceted recesses 280 is the same as the pitch P2 of between each two adjacent multi-faceted recesses of the second plurality of multi-faceted recesses 281. In one embodiment, the pitch P1 of between each two adjacent multi-faceted recesses of the first plurality of multi-faceted recesses 280 is different from the pitch P2 of between each two adjacent multi-faceted recesses of the second plurality of multi-faceted recesses 281. In one embodiment, the pitch P1 is in a range of 56-60 μm and the pitch P2 is in a range of 59-63 μm. In one embodiment, the thickness T1 of a multi-faceted recess of the first plurality of multi-faceted recesses 280 is in a range of 10-30 μm; the thickness T2 of the substrate, which can be made of PET, is in a range of 30-300 μm; the thickness T3 of a multi-faceted recess of the second plurality of multi-faceted recesses 281 is in a range of 5-50 μm. the total thickness of T1, T2 and T3 is in a range of 40-400 μm. The optical film of FIG. 2M can reduce the MURA effect by the circular shape structure at the bottom surface of the substrate 101 and avoid the formation of shadows after the light penetrates the optical film by the first plurality of multi-faceted recesses 280 formed on the top surface of the substrate 101.

FIG. 2N illustrates a photo that shows a conical recess structure on a top surface of the substrate 101.

FIG. 2O illustrates a photo that shows the light-splitting effect of the conical recess structure in FIG. 2M.

FIG. 2P illustrates a photo that shows the light-splitting effect of the conical recess structures when each of the top surface and the bottom surfaces of the substrate 101 has the conical recess structure in FIG. 2M.

FIG. 2Q illustrates a method for forming an optical film, the method comprising: step 201S: forming a plurality of cones, such as pyramids, protruding on a roller; and step 202S: forming a plurality of reversed cones, such as reversed pyramids, on a substrate by using the roller, wherein each reversed cones, such as a reversed pyramid, is created by a corresponding cone, such as a pyramid, protruding on the roller.

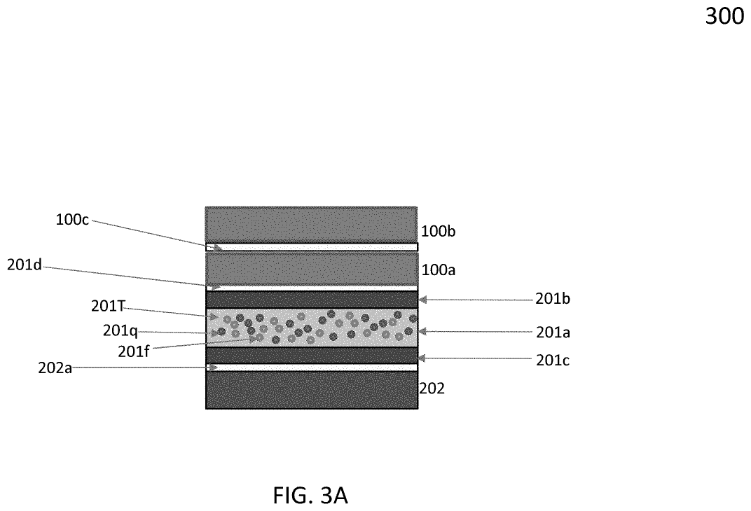

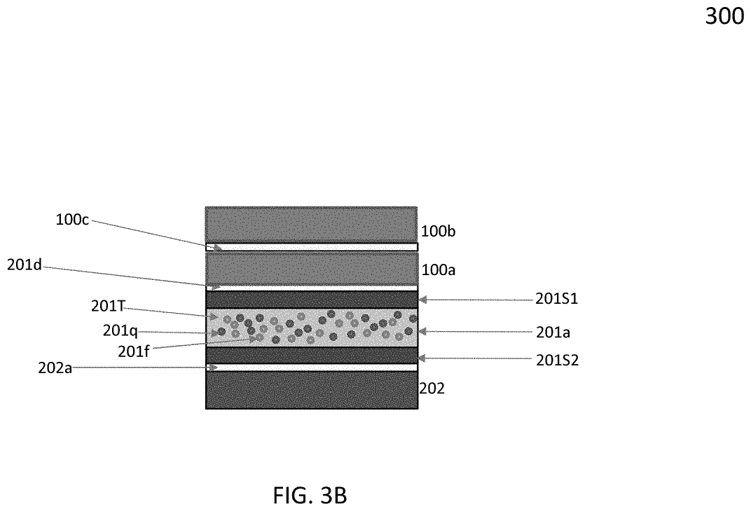

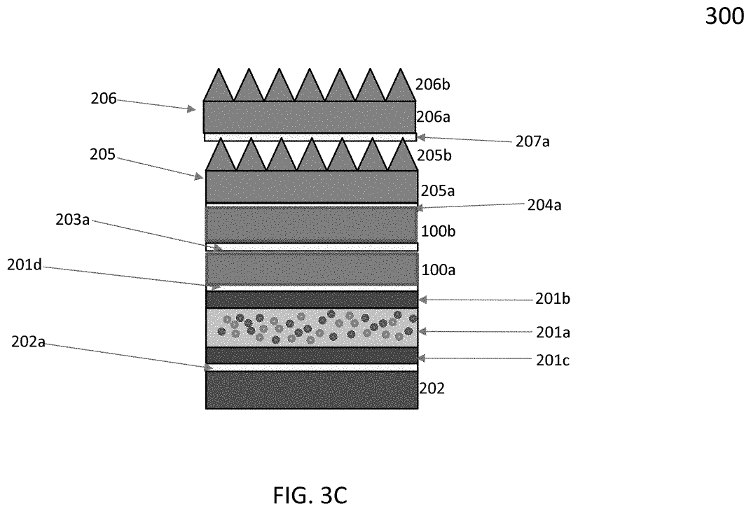

FIG. 3A illustrates a schematic top view of a composite optical film 300 according to one embodiment of the present invention, wherein the composite optical film 300 comprises: a quantμm-dot film comprising a quantμm-dot layer 201a and a first plurality of prisms 203 disposed over the quantμm-dot layer 201a; a first optical film 100a as disclosed in FIG. 1A or FIG. 1B, disposed over the quantμm-dot film 202, wherein a first plurality of multi-faceted recesses 103a are formed on a first surface of the first optical film 100a; and a second optical film 100b as disclosed in FIG. 1A or FIG. 1B, disposed over the first optical film 100a, wherein a second plurality of multi-faceted recesses 103b are formed on a first surface of the second optical film 100b.

In one embodiment, as shown in FIG. 3A, the composite optical film 300 further comprises a first adhesive layer 201d, wherein a second surface of the first optical film 100a is attached to the quantμm-dot film comprising the quantμm-dot layer 201a by the first adhesive layer 201d disposed between the quantμm-dot film comprising the quantμm-dot layer 201a and the first optical film 100a.

In one embodiment, as shown in FIG. 3A, the quantμm-dot film 201 comprises a quantμm-dot layer 201a, a first barrier layer 201b, and a second barrier layer 201b, wherein the quantμm-dot layer 201a is disposed between the first barrier layer 201b and the second barrier layer 201c, wherein a second surface of the first optical film 100a is attached to the first barrier layer 201b by the first adhesive layer 201d disposed between the first barrier layer 201b and the first optical film 100a.

In one embodiment, as shown in FIG. 3A, the composite optical film 300 further comprises a second adhesive layer 100c, wherein the second optical film 100b is attached to the first optical film 100a by the second adhesive layer 100c disposed between the first optical film 100a and the second optical film 100b.

In one embodiment, as shown in FIG. 3A, the composite optical film 300 further comprises a first adhesive layer 201d, wherein the first optical film 100a is attached to the first barrier layer 201b by the first adhesive layer 201d disposed between the first barrier layer 201b and the first optical film 100a.

In one embodiment, as shown in FIG. 3A, the quantμm-dot layer 201a comprises a binder 201T and a plurality of quantμm dots 201q dispersed in the binder 201T.

In one embodiment, as shown in FIG. 3A, the quantμm-dot layer 201a comprises a plurality of diffusing particles 201f dispersed in the binder 201T.

In one embodiment, each of the plurality of quantμm dots 201q is capable of being water-resistant and oxygen-resistant.

In one embodiment, as shown in FIG. 3B, the quantμm-dot film comprises a first substrate 201S1 and a second substrate 201S2, wherein the quantμm-dot layer is disposed between the first substrate 201S1 and the second substrate 201S2.

In one embodiment, as shown in FIG. 3B, each of the first substrate 201S1 and the second substrate 201S2 comprises PET (polyethylene terephthalate).

In one embodiment, as shown in FIG. 3B, each of the first substrate 201S1 and the second substrate 201S2 is a PET substrate.

FIG. 3C illustrates a schematic top view of a composite optical film 300 according to one embodiment of the present invention. In one embodiment, as shown in FIG. 3C, the composite optical film 300 further comprises a blue light transmissive film 202 disposed under the quantμm-dot film comprising the quantμm-dot layer 201a, wherein the blue light transmissive film 202 is capable of enhancing the transmittance of blue light and increasing the reflectivity of red and green light.

In one embodiment, as shown in FIG. 3C, the composite optical film 300 further comprises a third adhesive layer 202a, wherein the blue light transmissive film 202 is attached to the quantμm-dot film by the third adhesive layer 202a disposed between the quantμm-dot film comprising the quantμm-dot layer 201a and the blue light transmissive film 202.

In one embodiment, as shown in FIG. 3C, the composite optical film 300 further comprises a first brightness enhancement film 205 disposed over the second optical film 100b.

In one embodiment, as shown in FIG. 3C, the composite optical film 300 further comprises a second brightness enhancement film 206 disposed over the first brightness enhancement film 205.

In one embodiment, as shown in FIG. 3C, the first brightness enhancement film 205 comprises a first plurality of prisms.

In one embodiment, as shown in FIG. 3C, the second brightness enhancement film 206 comprises a second plurality of prisms.

In one embodiment, as shown in FIG. 3C, the first brightness enhancement film 205 comprises a first substrate and a first plurality of prisms disposed on the first substrate.

In one embodiment, as shown in FIG. 3C, the second brightness enhancement film 206 comprises a second substrate and a second plurality of prisms disposed on the second substrate.

In one embodiment, as shown in FIG. 3C, the composite optical film further comprises a fourth adhesive layer 204a, wherein the first brightness enhancement film 205 is attached to the second optical film 100b by the fourth adhesive layer 204a disposed between the first brightness enhancement film 205 and the second optical film 100b.

In one embodiment, as shown in FIG. 3C, the composite optical film further comprises a fifth adhesive layer 207a, wherein the first brightness enhancement film 205 is attached to the second brightness enhancement film 206 by the fourth adhesive layer 207a disposed between the first brightness enhancement film 205 and the second brightness enhancement film 206.

In one embodiment, as shown in FIG. 3C, the first brightness enhancement film comprises a first substrate and a first plurality of prisms disposed on the first substrate, wherein a top part of the first plurality of prisms is embedded in the fifth adhesive layer 207a.

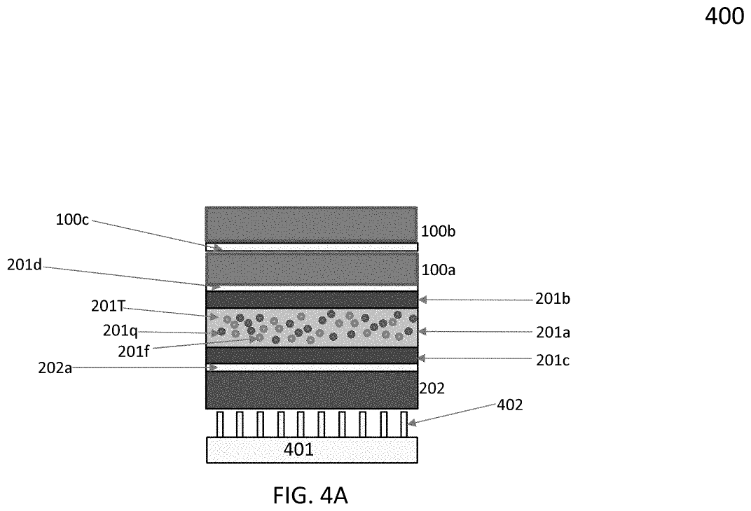

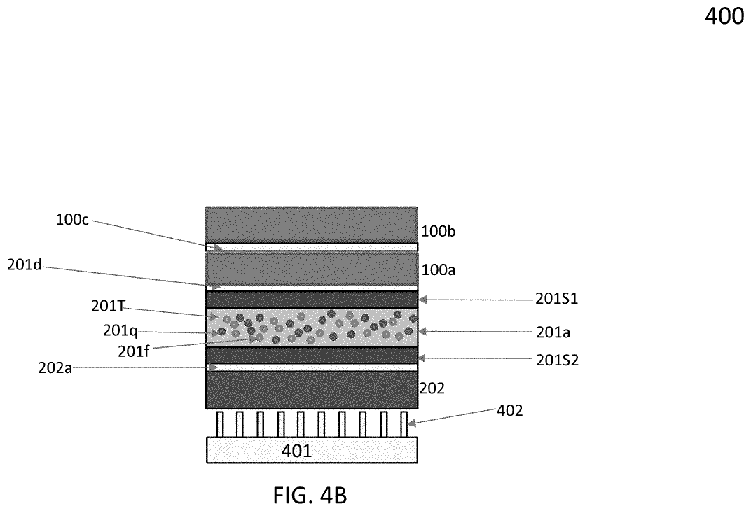

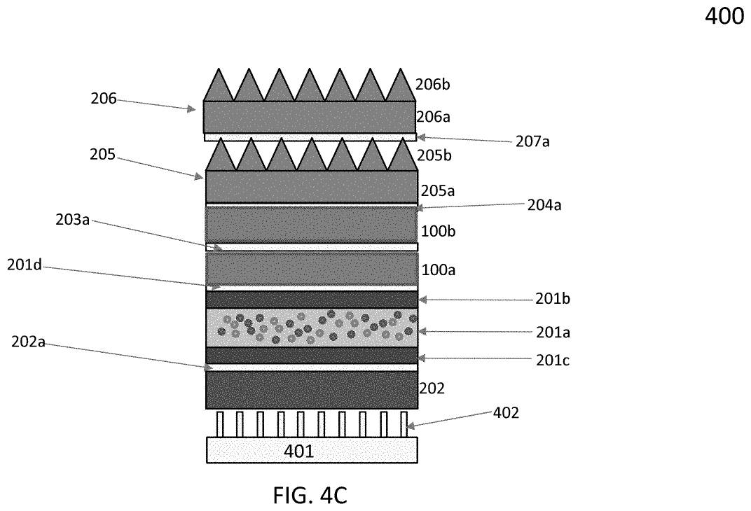

FIG. 4A illustrates a schematic top view of a backlight module 400 according to one embodiment of the present invention, wherein the backlight module 400 comprises the composite an optical film 300 as shown in FIG. 3A and a light source 401 located under the optical film 300. In one embodiment, the light source 401 comprises a plurality of mini-LED(s).

FIG. 4B illustrates a schematic top view of a backlight module 400 according to one embodiment of the present invention, wherein the backlight module 400 comprises the composite an optical film 300 as shown in FIG. 3B and a light source 401 located under the optical film 300. In one embodiment, the light source 401 comprises a plurality of mini-LED(s).

FIG. 4C illustrates a schematic top view of a backlight module 400 according to one embodiment of the present invention, wherein the backlight module 400 comprises the composite an optical film 300 as shown in FIG. 3C and a light source 401 located under the optical film 300. In one embodiment, the light source 401 comprises a plurality of mini-LED(s).

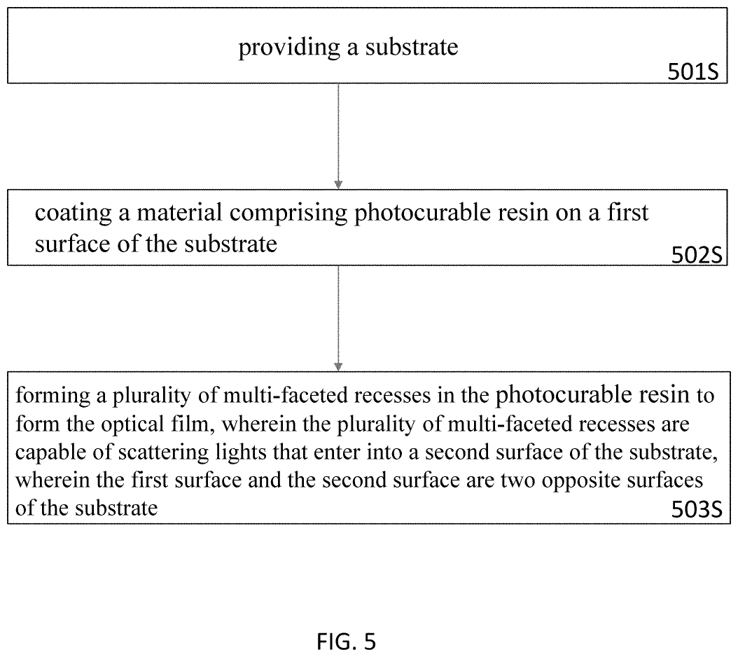

FIG. 5 illustrates a method to form an optical film according to one embodiment of the present invention, wherein the method comprises: step 501S: providing a substrate; step 502S: coated coating a material comprising photocurable resin on a first surface of the substrate; step 503S: forming a plurality of multi-faceted recesses in the photocurable resin to form the optical film, wherein the plurality of multi-faceted recesses are capable of scattering lights that enter into a second surface of the substrate, wherein the first surface and the second surface are two opposite surfaces of the substrate.

In one embodiment, as shown in FIG. 5, a method to form an optical film is disclosed, wherein the method comprises: providing a substrate; coating a material comprising photocurable resin on a first surface of the substrate; and forming a plurality of multi-faceted recesses in the photocurable resin, wherein the plurality of multi-faceted recesses are capable of scattering lights that enter into a second surface of the substrate, said first surface and said second surface are two opposite surfaces of the substrate.

In one embodiment, the multi-faceted recess comprises at least three side surfaces.

In one embodiment, the step of forming a plurality of multi-faceted recesses in the photocurable resin comprises: engraving a plurality of multi-faceted protrusions on a roller; forming the plurality of multi-faceted recesses in the photocurable resin by using the plurality of multi-faceted protrusions on the roller.

In one embodiment, the substrate comprises PET.

In one embodiment, the photocurable resin is made of UV resin.

In one embodiment, the substrate is made of PET.

In one embodiment, each of the plurality of multi-faceted recesses is a conical recess.

In one embodiment, each of the plurality of multi-faceted recesses comprises a shape of a reversed pyramid.

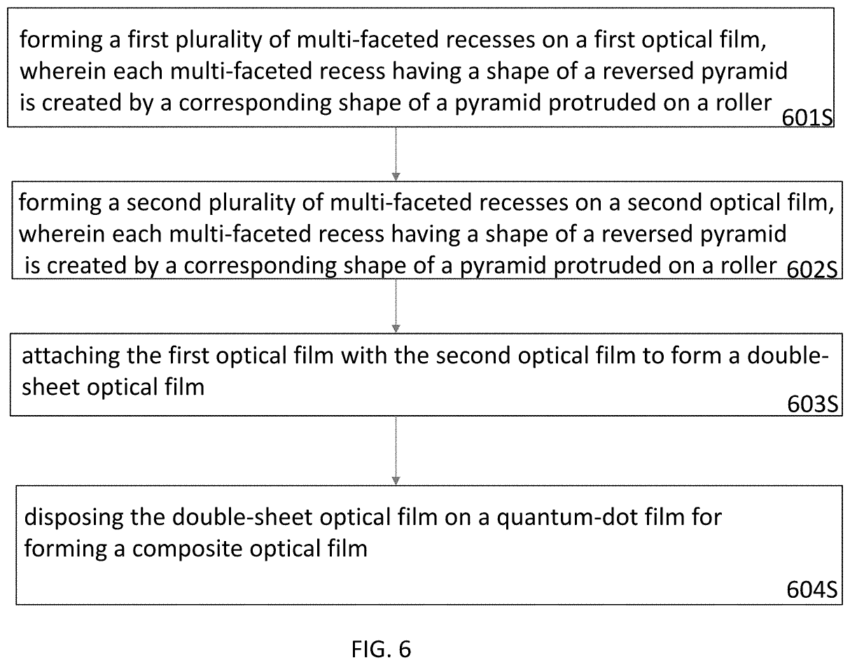

FIG. 6 illustrates a method to form an optical film according to one embodiment of the present invention, wherein the method comprises: step 601S: forming a first plurality of multi-faceted recesses on a first optical film, wherein each multi-faceted recess having a shape of a reversed-pyramid is created by a corresponding shape of a pyramid protruded on a roller; step 602S: forming a second plurality of multi-faceted recesses on a second optical film, wherein each multi-faceted recess having a shape of a reversed-pyramid is created by a corresponding shape of a pyramid protruded on a roller; step 6013S: attaching the first optical film with the second optical film to form a double-sheet optical film; and step 604S: disposing the double-sheet optical film on a quantum-dot film for forming a composite optical film.

In one embodiment, the multi-faceted recess comprises at least three side surfaces.

In one embodiment, the method further comprises forming a plurality of pyramids protruded on a roller, wherein the first plurality of multi-faceted recesses reversed-pyramids are formed on the first optical film by using the roller, wherein each multi-faceted recess having a shape of a reversed-pyramid is created by a corresponding pyramid protruded on the roller.

In one embodiment, the method further comprises disposing a blue light transmissive film under the quantum-dot film, wherein the blue light transmissive film is capable of enhancing the transmittance of blue light and increasing the reflectivity of red and green light.

In one embodiment, the method further comprises disposing a blue light transmissive film under the quantum-dot film, wherein the blue light transmissive film is capable of enhancing the transmittance of blue light and increasing the reflectivity of red and green light.

In one embodiment, the first optical film comprises PET.

In one embodiment, the second optical film comprises PET.

In one embodiment, a first brightness enhancement film is disposed over the second optical film.

In one embodiment, a second brightness enhancement film is disposed over the first brightness enhancement film.

In one embodiment, a backlight module according to one embodiment of the present invention is disclosed, wherein the backlight module comprises: a plurality of laser emitting diodes; and an optical film, wherein the optical film is located above the plurality of laser emitting diodes, for scattering lights from the plurality of laser emitting diodes entering into the optical film.

In one embodiment, each of the plurality of laser-emitting diodes is a mini LED.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A composite optical film, comprising:
a quantum-dot film, wherein a plurality of quantum dots are disposed in the quantum-dot film; and
a first optical film, disposed over the quantum-dot film, wherein a first plurality of multi-faceted recesses are formed on a first surface of the first optical film.

2. The composite optical film according to claim 1, wherein each multi-faceted recess of the first plurality of multi-faceted recesses comprises a shape of a reversed cone.

3. The composite optical film according to claim 1, further comprising:
a second optical film, disposed over the first optical film, wherein a second plurality of multi-faceted recesses are formed on a first surface of the second optical film.

4. The composite optical film according to claim 3, further comprising a first adhesive layer, wherein a second surface of the first optical film is attached to the quantum-dot film by the first adhesive layer disposed between the quantum-dot film and the first optical film.

5. The composite optical film according to claim 3, further comprising a second adhesive layer, wherein a second surface of the second optical film is attached to the first optical film by the second adhesive layer disposed between the first optical film and the second optical film.

6. The composite optical film according to claim 3, further comprising a blue light transmissive film disposed under the quantum-dot film, wherein the blue light transmissive film is capable of enhancing the transmittance of blue light and increasing the reflectivity of red and green light.

7. The composite optical film according to claim 3, further comprising a third adhesive layer, wherein the blue light transmissive film is attached to a bottom surface of the quantum-dot film by the third adhesive layer disposed between the bottom surface of the quantum-dot film and a top surface of the blue light transmissive film.

8. The composite optical film according to claim 3, further comprising a first brightness enhancement film disposed over the second optical film.

9. The composite optical film according to claim 9, further comprising a second brightness enhancement film disposed over the first brightness enhancement film.

10. The composite optical film according to claim 8, wherein the first brightness enhancement film comprises a first plurality of prisms.

11. The composite optical film according to claim 9, wherein the second brightness enhancement film comprises a second plurality of prisms.

12. The composite optical film according to claim 8, wherein the first brightness enhancement film comprises a first substrate and a first plurality of prisms disposed on the first substrate.

13. The composite optical film according to claim 9, wherein the second brightness enhancement film comprises a second substrate and a second plurality of prisms disposed on the second substrate.

14. The composite optical film according to claim 13, further comprising a fourth adhesive layer, wherein the first brightness enhancement film is attached to the second brightness enhancement film by the fourth adhesive layer disposed between the first brightness enhancement film and the second brightness enhancement film.

15. The composite optical film according to claim 14, further comprising a fifth adhesive layer, wherein the first brightness enhancement film is attached to the second optical film by the fifth adhesive layer disposed between the first brightness enhancement film and the second optical film.

16. The composite optical film according to claim 15, wherein the first brightness enhancement film comprises a first substrate and a first plurality of prisms disposed on the first substrate, wherein a top part of the first plurality of prisms is embedded in the fifth adhesive layer.

17. A backlight module comprising:
a light source; and
a composite optical film as recited in claim 1, wherein the composite optical film is located above the light source.

18. The backlight module according to claim 17, wherein the light source comprises a plurality of mini-LED(s).

19. A method to form a composite optical film, said method comprising:
forming a quantum-dot film; and
forming a first optical film, wherein the first optical film comprises a substrate, wherein a first plurality of multi-faceted recesses are formed on a top surface of the substrate;
disposed the first optical film over the quantum-dot film.

20. The method according to claim 19, wherein the step of forming a first optical film further comprising forming a second plurality of multi-faceted recesses on a bottom surface of the substrate.
